(19) United States
(12) Patent Application Publication
(10) Pub. No.: US 2025/0310770 A1
(43) Pub. Date: Oct. 2, 2025

(54) SYSTEM AND METHOD FOR AI-POWERED SMS MIRRORING WITH SENSITIVE DATA MASKING AND SESSION RECOVERY

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US)

(73) Assignee: CELLIGENCE INTERNATIONAL LLC, Guaynabo, PR (US)

(21) Appl. No.: 19/229,974

(22) Filed: Jun. 5, 2025

Related U.S. Application Data
(63) Continuation of application No. 19/229,943, filed on Jun. 5, 2025.
Application No. 19/229,943 is a continuation-in-part of application No. 18/135,703, filed on Apr. 17, 2023.
(60) Provisional application No. 63/332,205, filed on Apr. 18, 2022.

(51) Int. Cl. H04W 12/084; G06F 40/35; H04L 51/02; H04M 1/72436; H04M 1/72445; H04W 12/02; H04W 12/61; H04W 12/63

(52) U.S. Cl. CPC H04W 12/084; H04L 51/02; H04M 1/72436; H04M 1/72445; H04W 12/02; H04W 12/61; H04W 12/63; G06F 40/35

(57) ABSTRACT

Systems and methods are provided for maintaining secure mirrored interactions across SMS and web-based conversational interfaces. Upon session initiation, chat updates are mirrored to the SMS channel in real time. Sensitive information within mirrored messages is automatically detected using natural language processing and masked prior to SMS delivery. Full chat histories, form inputs, and session metadata are persistently stored in encrypted storage, allowing users to pause and later resume the session by reinitiating an SMS conversation. The system ensures continuity, privacy, and real-time synchronization while minimizing exposure of sensitive user data across messaging channels.

### RELATED APPLICATIONS

This application a continuation of and claims the benefit of U.S. patent application Ser. No. 19/229,943, filed Jun. 5, 2025, which is a continuation-in-part of and claims the benefit of U.S. patent application Ser. No. 18/135,703, filed on Apr. 17, 2023, which claims the benefit of U.S. Provisional Application No. 63/332,205 filed on Apr. 18, 2022, each of which is hereby incorporated herein by reference in the respective entirety of each.

### FIELD

The present disclosure relates to systems and methods for secure, AI-driven conversational interfaces that integrate mobile SMS communication with browser-based chat experiences for completing electronic forms. More specifically, the disclosure relates to synchronizing structured data input and conversational workflows across SMS and web platforms with secure session handling, masking of sensitive data, and audit tracking.

### BACKGROUND

Completing electronic forms for tasks such as loan applications, insurance claims, or registration workflows often requires the user to navigate a rigid, form-based graphical user interface. These experiences are prone to abandonment due to complexity, lack of flexibility, and poor mobile optimization. In parallel, users frequently use SMS as their default messaging tool, particularly when dealing with time-sensitive or low-bandwidth interactions. Existing systems fail to bridge these modalities effectively-offering either a limited SMS-only experience or forcing users into app-based environments that compromise convenience or privacy.

Furthermore, SMS messages are inherently insecure for transmitting personally identifiable information (PII), such as Social Security numbers, addresses, or financial data. Conventional systems that collect such data through SMS lack proper redaction, session control, and structured integration with back-end workflows. Users are often required to repeat steps, re-authenticate, or abandon their effort due to disjointed platform transitions and lack of support for session persistence.

There exists a need for a system that allows users to initiate form-completion workflows via SMS, receive a secure link to a browser-based chat interface, and have their session mirrored between SMS and browser environments with full synchronization of data, privacy protection, and session state. The disclosed system addresses these and other problems in the art.

### SUMMARY

The disclosed system enables AI-driven secure conversational workflows by maintaining a real-time mirrored interaction between an SMS channel and a secure web-based chat interface. Following session initiation, the system mirrors chat updates across interfaces while dynamically detecting and masking sensitive user data from outbound SMS messages. Masking is performed based on contextual analysis of user inputs, applying obfuscation, token replacement, or omission to preserve privacy. All interactions, including masked and original data, are logged and stored securely in an encrypted session persistence layer. Users may pause the conversation and later resume it by sending a follow-up SMS, which triggers recovery of prior session history, chat states, and structured data entries. The system leverages machine learning models to classify sensitive content, prioritize data retention, and streamline user re-engagement workflows, ensuring both security and seamless form completion across messaging platforms.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A illustrates a secure SMS mirroring system where user input via SMS is mirrored to a secure web-based chat interface, according to an implementation of the disclosure.

FIG. 1B illustrates the communication flow between SMS, a web chat UI, and backend modules, according to an implementation of the disclosure.

FIG. 2 depicts the modular architecture of the backend system, according to an implementation of the disclosure.

FIG. 3A illustrates a mobile device receiving a secure link via SMS that opens a web-based chat interface, according to an implementation of the disclosure.

FIGS. 3B-3C illustrate a mobile device receiving a secure hyperlink via SMS and launching a web-based chat interface through a browser, according to an implementation of the disclosure.

FIGS. 4A-4B illustrate redaction and masking process of sensitive user-provided data, including the visual transformation from unmasked content to a masked version as displayed in both the chat interface and the mirrored SMS thread, according to an implementation of the disclosure.

FIG. 5 illustrates an example computing system that may be used in implementing various features of embodiments of the disclosed technology.

Described herein are systems and methods for enabling secure, intelligent conversational workflows that improve electronic form completion and user data intake. These systems provide a natural language chat interface—accessible via SMS and browser-based sessions—for interacting with an automated software assistant (AA) and, when needed, a human assistant (HA). The assistant guides users through structured workflows such as document upload, identity verification, or financial applications, using adaptive prompts, secure session management, and privacy-preserving features such as selective data masking. The following description sets forth several illustrative embodiments of the disclosed system, including modular architecture, messaging logic, and multi-device support. Other features and advantages will become apparent to those skilled in the art upon review of the specification, drawings, and claims. It is intended that all such systems, methods, features, and enhancements be considered within the scope of the present disclosure and protected by the accompanying claims.

### DETAILED DESCRIPTION

The disclosed system consists of a backend computing server and one or more client computing devices that facilitate bidirectional conversational workflows across SMS and web interfaces. The system supports secure transmission and intelligent parsing of user-provided content, enabling AI-assisted form completion with persistent session context, multi-session handling, data masking, and auditability.

Conventional systems for form completion and digital intake are often rigid, web-form-centric, and disconnected from the way users actually initiate communication-especially in mobile-first or low-bandwidth environments. Most such systems rely on a browser-based experience or a mobile application that must be downloaded and configured in advance. These solutions assume that the user begins and ends the interaction within a single interface, typically a static form, without support for conversational guidance, real-time correction, or session flexibility.

Moreover, existing systems lack support for initiating workflows via text messaging (e.g., SMS) and do not offer a seamless transition between channels. Users who begin communication via SMS are typically forced to restart the process in a separate environment or are redirected to static landing pages that do not preserve session context or adapt to prior inputs.

These systems also fail to address the risks associated with transmitting sensitive information over unsecured messaging channels. Most lack any form of selective data masking, audit-tracked message mirroring, or compliance-aware content redaction. As a result, they either expose sensitive data via SMS or avoid the channel altogether-limiting accessibility and utility.

The methods and techniques disclosed herein produce several technical effects and advantages over conventional systems. These include enabling secure session transitions from SMS to a browser-based chat interface without requiring users to install an application or enter login credentials. By generating a secure, time-limited hyperlink in response to an SMS, the system facilitates seamless, low-friction session initiation while preserving security and context.

Additional advantages include selective data masking of sensitive information-such as Social Security numbers, addresses, or income data-when mirroring content back to the SMS thread. Unlike systems that either transmit all content unmasked or restrict SMS usage entirely, the disclosed system applies intelligent masking logic to ensure privacy while maintaining conversational continuity.

The system also supports real-time session resumption via SMS re-engagement. Users can return to an in-progress session simply by sending a follow-up SMS, triggering automatic session rehydration and secure link generation. This behavior is supported by persistent chat history, structured data storage, and an AI assistant that adapts conversational flow based on prior engagement patterns.

These techniques enable an adaptive, channel-aware user experience that balances convenience, privacy, and compliance-making it possible for users to engage in structured workflows such as form completion, document upload, and intent clarification across disconnected devices and messaging modalities.

As alluded to above, the disclosed system facilitates secure conversational interactions that bridge SMS and web-based interfaces to guide users through the process of completing an electronic form. The system includes several key components and modules, including but not limited to SMS gateway, NLP and intent engine, secure link generator, session manager, data masking and redaction module, ad audit logging module.

For example, and as will be described in grater detail further, the SMS gateway serves as the communication ingress and egress point for all user text messages. It receives inbound SMS, identifies the associated user, and forwards the message to the NLP and intent engine. It also delivers mirrored content and secure links back to the user, while managing rate limits, retries, and delivery acknowledgments. The NLP and intent engine performs natural language understanding on inbound SMS content. It extracts key phrases, intent, and structured entities such as document types, loan numbers, contact information, or sentiment. Upon recognition of a valid request or known pattern, the secure link generator creates a secure hyperlink embedded with a single-use, time-limited token. This URL, sent via SMS, grants access to a web-based interface linked to the originating user and session. The session manager tracks ongoing user interactions, form state, and associated structured data. It enables the user to pause the chat, resume later via SMS, and ensures that the most recent state—including masked fields and folder associations—is preserved across sessions. To protect user privacy, data masking and redaction module detects sensitive fields such as Social Security numbers, financial details, and addresses. When such data is mirrored to the SMS channel, the system applies tokenization or symbolic masking to prevent exposure. Finally, all user actions, system responses, masking events, session transitions, and authentication steps are recorded in a secure, tamper-evident log by the audit logging module. This log supports compliance verification, fraud analysis, and operational audits.

The system supports session persistence across asynchronous user behavior. A user who initiates an interaction, receives a secure link, and begins completing a form in the chat interface may pause the session at any time. If the user sends a subsequent SMS message at a later time, the Session Manager restores the user's session context including prior messages, structured form data, and masked/unmasked field states. This feature allows flexible, multi-touch engagement with high user retention.

The system supports the management of multiple simultaneous sessions. When a user includes an identifier—such as a loan number—in their SMS, the NLP and Intent Engine recognizes the identifier and associates the message with a specific session or folder. The Session Manager uses this mapping to present the correct session state, even if the user is working on multiple applications concurrently.

Upon initiating a mirrored chat session, the system may offer context-sensitive prompts or quick requests. For instance, if the SMS message suggests a user wants to provide banking information, the system will automatically open the form section for financials and prompt the user with guided questions. These prompts are generated by the NLP engine and tailored using historical engagement data.

To ensure privacy, any PII or sensitive data entered by the user is detected and masked prior to mirroring in the SMS thread. Users may also manually trigger masking using chat interface controls (e.g., a toggle or masking icon). Alternatively, if the user types a phrase such as ‘keep this private’ after a message, the system will retrospectively apply masking logic to the relevant content.

After receiving a secure link, the user accesses a browser-based chat interface that mirrors the prior SMS exchange. Any messages sent from the secure interface that are not sensitive may be echoed back into the SMS thread. The mirrored history gives users continuity and confidence while allowing secure input capture and enhanced interactivity.

A user initiates the interaction by sending a message to the system via SMS. This message is received by the SMS Gateway and forwarded to the NLP and Intent Engine for parsing. The engine applies rule-based and machine learning techniques to detect user intent and extract structured data from the message.

Upon determining that a user requires a secure interaction—for example, due to the nature of the data provided or based on conversation context—the system invokes the Secure Link Generator. This module generates a single-use, time-limited URL that is embedded with a secure token linked to the user's mobile number and session metadata. The secure hyperlink is transmitted back to the user through the SMS Gateway. When the user clicks the link, they are directed to a secure web-based chat interface.

This secure chat interface mirrors the prior SMS conversation and enables further interaction with the assistant (AA). If the user previously provided structured data, such as a loan number or email address, the system uses this information to pre-load the relevant form sections. If the user abandoned the process previously, the session manager restores the session to its most recent state, including uncompleted form fields, previously masked data, and the interaction history with the assistant.

The system synchronizes all user inputs and assistant responses between the SMS channel and the web-based chat interface. In cases where a message contains sensitive information, the data masking and redaction module is activated. This module identifies and redacts personally identifiable information in outbound mirrored messages. For example, if a user submits ‘My SSN is 123-45-6789’, the mirrored SMS message might appear as ‘My SSN is ***_**_****’, while the secure web interface retains the full content in encrypted form.

The audit logging module captures all interaction events, message exchanges, masking decisions, session transitions, and prompt responses. These logs are stored in a secure and tamper-resistant format, providing traceability for compliance, debugging, or audit purposes. Optionally, the system may flag high-risk activity or anomalous message content using built-in anomaly detection logic.

Throughout the session, the conversational AI assistant (AA) may proactively generate intelligent prompts and quick requests based on prior inputs and current context. These prompts are delivered in both SMS and web interfaces, adapted to the available UI features. For example, if a user texts, ‘I need to upload my W-2,’ the assistant may respond with a secure upload link or a prompt to connect payroll providers. The assistant may also re-sequence questions or present a simplified form if the user's behavior suggests confusion or drop-off risk.

When a user navigates back to the chat interface—either through a newly received link or by replying to the SMS thread—the session manager identifies the prior session via token or phone number and restores the active context. This includes chat history, masked/unmasked data, completed and incomplete form sections, and session metadata. This continuity ensures a low-friction experience that improves form completion rates.

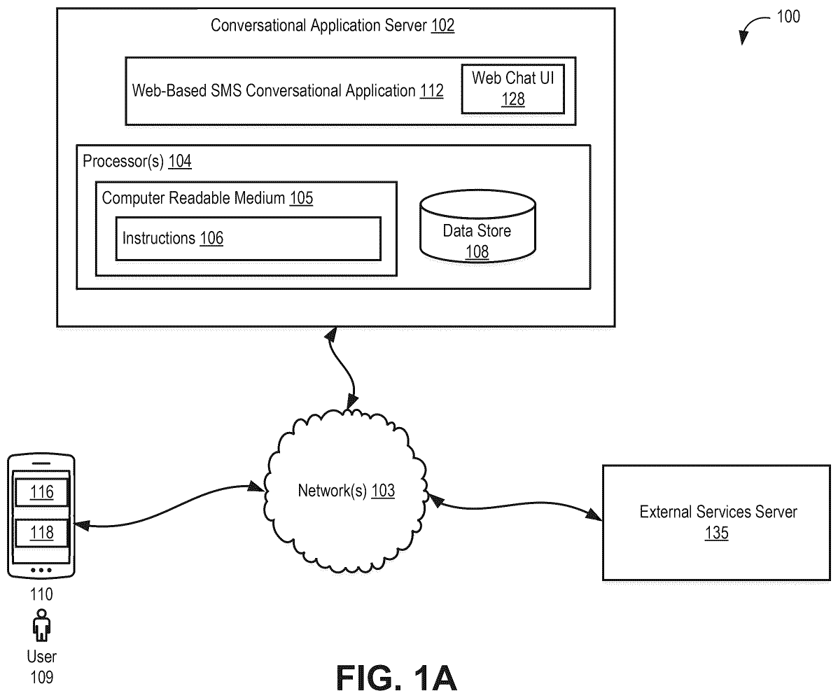

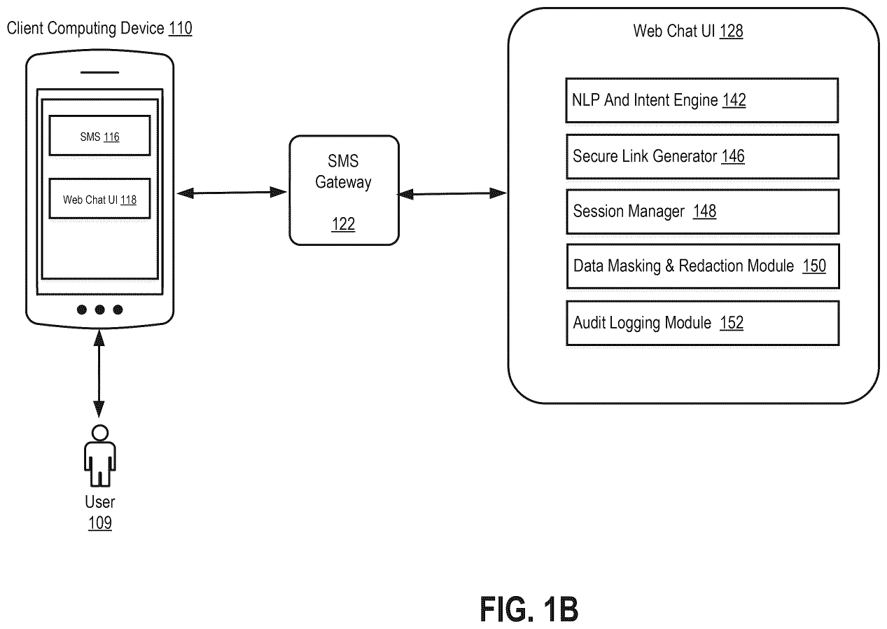

FIG. 1A illustrates an example architecture of a secure SMS mirroring system 100, in which a user 109 engages with a conversational application server 102 using a client computing device 110 over one or more networks 103. The client device 110 may transmit an initial message via SMS or access a browser-based session via a secure hyperlink. The conversational application server 102 executes a web-based SMS conversational application 112, leveraging one or more processors 104 to execute instructions 106 stored in a machine-readable medium 105.

The web-based SMS conversational application 112 includes or serves the browser-based web chat UI 128 (illustrated in FIG. 1B and discussed in detail below), which enables users to engage with the assistant interface after clicking a secure link transmitted via SMS. While the application 112 handles processing, session logic, and secure message handling on the server side, the web chat UI 128 provides the interactive experience rendered in the user's browser. User data, chat history, and structured form inputs may be stored in a data store 108. Server 102 may further communicate with one or more external services servers 135 to retrieve documents, perform authentication, or integrate with third-party workflows.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

Client computing device 110 serves as the primary interface for user 109 to initiate and engage in a conversational session with system 100. The device supports both SMS-based messaging and a secure browser-based chat interface. In some embodiments, the device includes a native messaging application 116 capable of sending and receiving SMS, and a web-based chat interface 118 for interacting with the secure web chat once the user has activated a session-specific hyperlink.

The SMS interface 116 enables the user to begin interaction with the system using natural language messages, which are routed through the SMS Gateway 122. Upon detecting a request or prompt requiring secure data entry, the system responds with a secure link that opens a web chat interface 118. This browser-based interface, hosted by server 102, renders AI-generated prompts, captures structured inputs, and mirrors relevant portions of the conversation.

In some embodiments, a conversational AI assistant (AA) guides the user across both interfaces. The AA may operate remotely on server 102 and supports real-time interaction through SMS and web chat. It performs natural language understanding, intent classification, and dynamic workflow generation. In cases where ambiguity, user hesitation, or potential drop-off is detected, the system may escalate the session to a human assistant (HA) without disrupting the user's session state.

In some configurations, portions of the conversational interface may be optionally embedded within a native or hybrid mobile application if available on the client device 110. However, the system does not require any installed app for functionality. Core interaction capabilities—including secure session initiation, masked message mirroring, and AI-guided workflows—are fully supported through standard SMS and browser environments.

In some embodiments, a conversational AI assistant (AA) is provided by the web-based SMS conversational application 112, which is executed by SMS-based conversational interaction server 102. The AI assistant interacts with users through natural-language conversation, guiding them through structured workflows such as document submission, data verification, or form completion. The AA may receive inputs via SMS or through a secure browser-based chat interface and dynamically adjust the interaction flow based on intent, context, and session state.

In some embodiments, the AI assistant may be implemented as a third-party service integrated into the system 100. The assistant operates on the server-side and does not require installation on the user's client device. It processes conversational inputs, generates appropriate prompts or follow-up questions, and delivers structured guidance throughout the user's interaction.

The AI assistant is configured to parse user responses in real time, classify intent, and generate context-aware prompts and clarifications. As users engage with the system across SMS or web chat, the assistant may dynamically adjust the sequence and format of presented questions, ensuring that the experience remains intuitive, responsive, and personalized.

In some embodiments, the assistant may also support voice-based interactions. Users may speak responses via voice-enabled browsers or voice-to-text services, which are transcribed and analyzed in real time. Synthesized speech output may be used for response playback, including the use of voice avatars to distinguish between the AI assistant and any human assistant (HA) escalation, where applicable.

The AI assistant continuously monitors interaction signals—such as delayed responses, repeated clarification requests, or negative sentiment—and dynamically adjusts its strategy. These adjustments may include simplifying questions, summarizing previously captured inputs, or switching modalities (e.g., from freeform to multiple choice). The assistant's adaptability improves user engagement and reduces abandonment risk.

In addition to dynamic prompting, the system may generate micro-workflows or follow-up sequences based on predictive modeling. For example, if a user uploads a pay stub, the assistant may automatically initiate an income verification path. These workflows are context-aware and designed to minimize manual input while improving overall task completion.

When the assistant determines that user responses are incomplete, ambiguous, or indicate frustration or hesitation, the system may initiate a handoff to a human assistant (HA). The HA joins the session with full access to the user's chat history, form state, and prior assistant decisions, ensuring that the transition is seamless, and that the user does not need to repeat information.

The AI assistant may also generate suggested prompts and workflow continuations for the HA to use. These suggestions may be informed by machine learning models trained on prior sessions and optimized to improve resolution speed and user satisfaction. For example, if a user appears stuck during identity verification, the assistant may recommend the HA ask, “Would you like to upload a photo ID or link your identity provider account?”

FIG. 1B illustrates a communication flow diagram according to an implementation of the disclosure. In this functional architecture, backend modules 142-152, executed by SMS-based conversational interaction server 102, support interaction between a user's SMS session and a secure web-based chat interface. A client computing device 110 operated by a user 109 includes an SMS messaging interface 116 and a web chat interface 118. Messages from the user are transmitted via an SMS Gateway 122 to a web chat UI 128, which hosts various backend components including a natural language processing (NLP) and intent engine 142, secure link generator 146, session manager 148, data masking and redaction module 150, and audit logging module 152. These components collectively support secure, mirrored conversational workflows between SMS and web-based platforms.

The web chat interface 118 displayed on client computing device 110 is rendered based on Web Chat UI logic 128 hosted on server 102. While interface 118 presents the rendered output and accepts user interaction, web chat UI 128 coordinates assistant behavior, prompt generation, redaction logic, and session synchronization in real time. Messages mirrored to or from the SMS channel are managed within this layer.

Web chat UI 128 functions as the presentation and interaction layer generated by the web-based SMS conversational application 112 (illustrated in FIG. 1A). Application 112 provides the full conversational logic stack—including message parsing, intent classification, data masking, session control, and AI assistant functionality—while UI 128 delivers the dynamic user experience rendered in the user's browser following secure link activation.

Modules 142-152 operate as subcomponents of web chat UI 128 and power core features such as secure link generation, session continuity, audit-tracked redaction, and dynamic conversation flow. Together, these components enable seamless transitions from SMS to a secure browser session while preserving continuity, privacy, and usability.

The SMS Gateway 122 serves as the communication ingress and egress point for all user text messages. It receives inbound SMS, identifies the associated user, and forwards the message to the NLP and Intent Engine. Outbound messages—including secure links and mirrored assistant responses—are transmitted back through the gateway 122. The gateway 122 supports retry logic, delivery status tracking, and throttling to mitigate abuse or overload.

The NLP and Intent engine 142 performs natural language parsing, user intent classification, and entity extraction. It detects structured inputs such as document types, identification numbers, and key phrases. The NLP engine 142 may rely on rules-based logic, machine learning classifiers, or transformer-based models. Output is passed to downstream modules to initiate relevant workflows, generate prompts, or activate secure session generation.

Upon recognition of a valid request or known pattern, the secure link generator 146 creates a secure hyperlink embedded with a single-use, time-limited token. This URL, sent via SMS, grants access to a web-based interface linked to the originating user and session.

The session manager 148 tracks session continuity, chat state, document uploads, and structured field entries. It supports pause-and-resume functionality across devices by associating incoming SMS messages with active or recent sessions. The session manager 148 can recover prior session state based on phone number, message content, and timestamps, enabling users to re-engage workflows without logging in or repeating steps.

The data masking and redaction module 150 evaluates outbound messages for sensitive information and applies masking rules to protect user privacy before sending mirrored content to the SMS channel. Sensitive content such as account numbers or SSNs may be obfuscated using placeholder characters or removed entirely from the SMS copy while remaining available in the secure browser interface. Masking decisions are logged for audit purposes.

All key system events—including message receipt, assistant prompts, secure link generation, session transitions, and masking operations—are recorded in a tamper-resistant audit log by audit logging module 152. Each log entry includes session metadata, user identifier, timestamps, and action details. The logs support export in structured formats and integration with compliance dashboards, security monitoring platforms, or internal review tools.

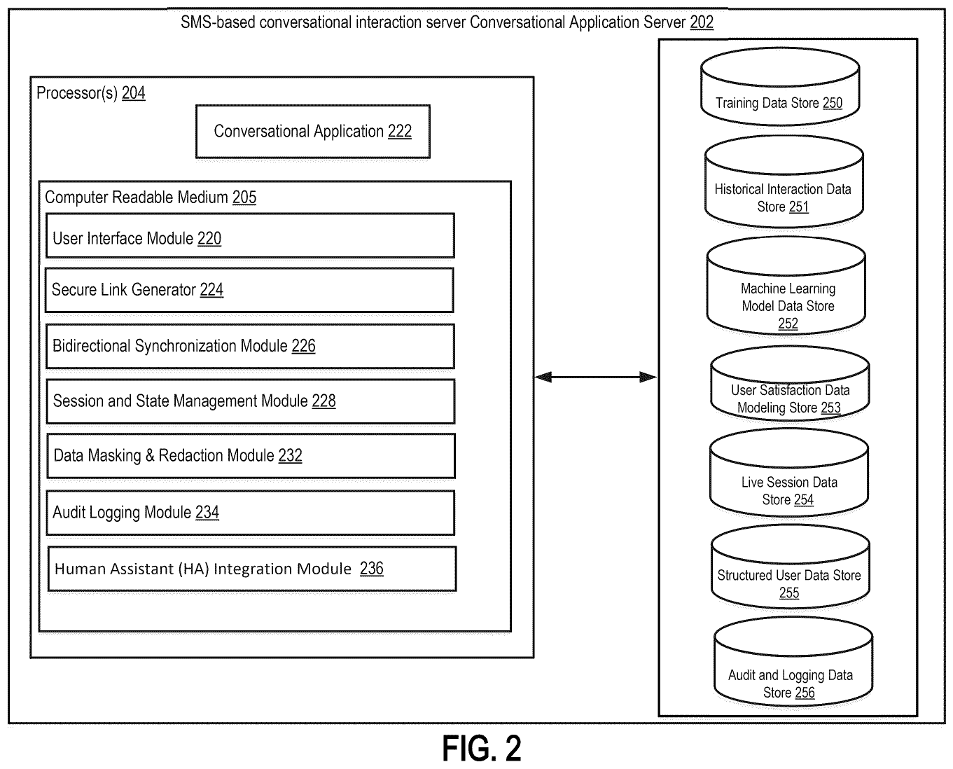

FIG. 2 illustrates the modular architecture of the SMS-based conversational interaction server 202, which corresponds to the conversational application server 102 shown in FIGS. 1A-1B. Server 202 is responsible for orchestrating session logic, handling SMS input, generating secure links, maintaining persistent session state, and synchronizing user activity across mobile and web-based interfaces. It supports and executes the backend modules illustrated in FIG. 1B (e.g., NLP engine, masking module), and further decomposes these capabilities into specialized logical components as illustrated in FIG. 2. Server 202 communicates with one or more client computing devices 110 over a network 103, as shown in FIGS. 1A-1B.

The server 202 includes a processor 204 configured to execute modules stored in a machine-readable medium 205. These modules operate in coordination to deliver adaptive, privacy-conscious conversational workflows and to support multi-channel interactions across SMS and browser-based chat interfaces. The architecture emphasizes modularity, secure data handling, real-time synchronization, session recovery, and intelligent assistant behavior across disconnected messaging environments.

In some embodiments, the server 202 may include a user interface module 220, a secure link generator 224, a bidirectional synchronization module 226, a session and state management module 228, a data masking and redaction module 232, an audit logging and compliance module 234, and a human Assistant (HA) integration module 238. These modules 220-236 shown in FIG. 2 represent logical extensions and functional subdivisions of the backend modules 142-152 shown in FIG. 1B. For example, the natural language processing and intent engine 142 of FIG. 1B is expanded into discrete components for context retention, ambiguity resolution, and fallback prompting, while the session manager 148 is represented by modules for bidirectional synchronization (e.g., through diversional synchronization module 226), structured state persistence (e.g., through session and state management module 228), and user re-engagement. This modular architecture enables finer-grained control, parallel execution, and improved traceability for each function performed by the system.

The user interface module 220 may be configured to manage bidirectional communication between the user and the AI assistant (AA) across both SMS and web interfaces. The module 220 is responsible for coordinating presentation logic, integrating incoming SMS content with mirrored browser-based interactions, and rendering adaptive interface elements such as prompts, tooltips, and contextual help. The module 220 ensures compatibility with mobile browser constraints, accessibility standards, and real-time synchronization events.

The secure link generator 224 may be configured to generate single-use, time-bound URLs embedded with session metadata and tied to the user's phone number. Used to transition users from SMS to secure web-based sessions. Token expiration logic, retry thresholds, and failover recovery modes are built in.

The bidirectional synchronization module 226 may be configured to maintain live synchronization between the SMS channel and the secure chat interface. Updates submitted through either channel are reflected in real time using a combination of REST APIs and WebSocket infrastructure. Conflict resolution logic ensures consistency between user inputs, assistant responses, and form state. This module interfaces with the Session Manager to persist data and update views dynamically.

The session and state management module 228 may be configured to track session continuity across devices, interfaces, and user re-engagement windows. Additionally, the session and state management module 228 may be configured to associate inbound SMS with active sessions, enabling seamless pause-and-resume functionality. Module 228 also stores structured form inputs, chat history, document upload references, and masking decisions. Finally, module 228 coordinates with audit logging for traceability and with the NLP engine 128 for context-aware re-entry.

The data masking and redaction module 232 may be configured to identify and mask sensitive data in mirrored SMS messages, while maintaining the full unmasked record in the secure web UI. Module 232 supports regex-based redaction, trained classifiers, and user-specified override logic (e.g., ‘please keep this private’).

The audit logging and compliance module 234 may be configured to capture system actions, user inputs, AI decisions, escalations, and redaction events in a tamper-resistant audit log. Module 234 may also provide exportable reports for compliance teams and supports fine-grained traceability down to the message level.

Human assistant (HA) integration module 236 may be configured to coordinate seamless handoff to human assistants if the AA detects user frustration, intent ambiguity, or repeated failure to complete a task. Module 236 may provide HA with full session snapshot, suggested prompts, and edit history.

The system 100 may be configured to use a series of specialized data stores to support learning, real-time interaction, session recovery, and compliance workflows, including a training data store 250, a historical interaction data store 251, a machine learning (ML) model repository 252, a satisfaction index modeling data sore 253, a live session data store 254, a structured user data store 255, and an audit and logging store 256. In some embodiments, the training data store 250 may be configured to contain labeled SMS/chat transcripts used to train intent models, redaction classifiers, and prompt sequencing algorithms. The historical interaction data store 251 may be configured to retain session logs, navigation patterns, form field completion sequences, and user retry behavior for optimization. The machine learning (ML) model repository 252 may be configured to store trained model weights, configuration files, inference logs, and feedback loops. The satisfaction index modeling data sore 253 may be configured to maintain user experience metrics such as completion time, retry frequency, sentiment score, and abandonment risk. The live session data store 254 may be configured to hold in-progress data from active SMS and chat interactions including partial form data, masking flags, and temporary tokens. The structured user data store 255 may be configured to securely store validated user input (e.g., names, SSNs, loan numbers, addresses) in a normalized schema. The audit and logging store 256 may be configured to preserve timestamped records of AI assistant actions, user inputs, masking decisions, HA handoffs, and system messages.

As part of the modular server architecture illustrated in FIG. 2, and corresponding to module 142 in FIG. 1B, the system's NLP and intent engine 142 is configured to handle a wide range of user input types, including ambiguous, colloquial, or partially structured messages. For example, if a user sends the SMS: “I want to fix that income thing I mentioned,” the NLP engine 142 applies historical session context, pronoun resolution, and message threading to infer that the user is referring to a prior income verification task. The NLP engine 142 may automatically surface the relevant form section or confirm the user's intent before resuming the workflow.

In some embodiments, the NLP engine 142 maintains short-term conversation memory across both SMS and web-based chat interfaces to resolve context-dependent references (e.g., “this,” “that form,” or “the last one”). Trained machine learning models analyze historical input patterns, context switches, and user behavior to detect intent transitions and generate contextually relevant prompts. These prompts may include clarifying follow-up questions, quick action shortcuts (e.g., “Would you like to re-upload your pay stub?”), or dynamic branching options based on user role or progress.

When the system's confidence in intent classification falls below a configurable threshold, the assistant applies fallback strategies to maintain engagement. In such cases, the assistant may respond with clarification templates such as, “Sorry, I didn't quite catch that. Would you like to update your income, address, or something else?” These strategies are designed to reduce user frustration, minimize error propagation, and keep the workflow moving forward in a natural, user-centric manner.

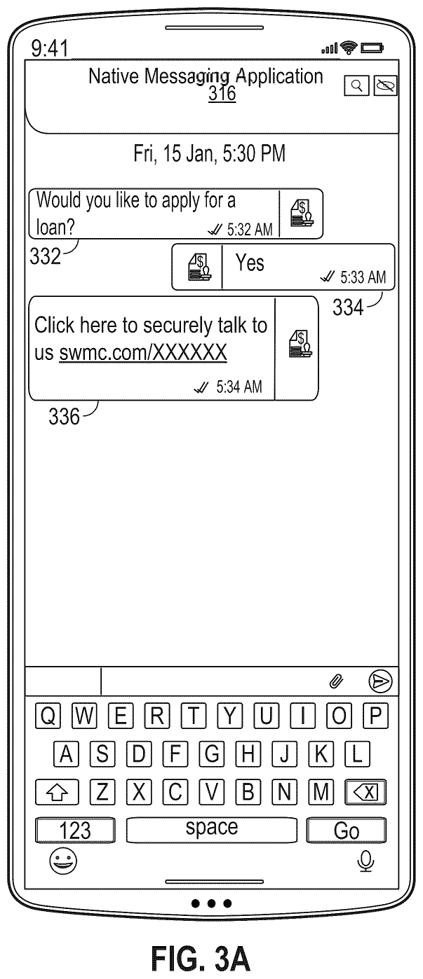

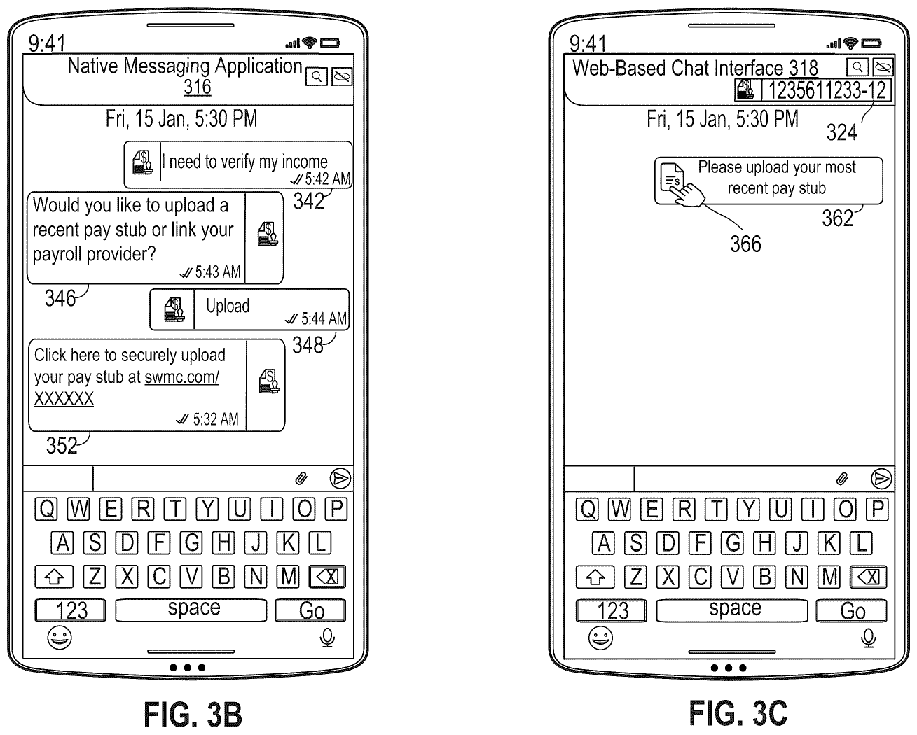

In some embodiments, the user 109 may not have a previously installed chat application or dedicated interface configured for structured data input or natural language communication. In such cases, the interaction may begin through a native SMS interface 116 on user computing device 110. For example, as illustrated in FIG. 3A, the system transmits an initial message 332 via SMS, such as “Would you like to apply for a loan?” The user may respond 334 with a text message reply, such as “Yes.” This exchange occurs through the device's native messaging application and is facilitated by the SMS Gateway 122 (illustrated in FIG. 1B).

In response to the user's affirmative reply, the assistant sends an additional SMS message 336 containing a secure hyperlink (e.g., “Click here to securely talk to us swmc.com/XXXXXX”). This link is generated by the secure link generator 146 and, when activated, opens a secure browser window on the user's device. The browser loads a dynamic web-based chat interface rendered by the web chat UI 128, which is generated and controlled by the web-based SMS conversational application 112 (illustrated in FIGS. 1A-1B).

This interface allows the user to engage with the assistant using natural language text, complete structured workflows, and upload documents relevant to the interaction—such as for a mortgage loan application or financial verification task—without requiring the user to download or install the conversational application beforehand. This reduces user friction, eliminates platform dependency, and allows the system to support mobile-first or low-bandwidth environments where app installation may be impractical or delayed. By removing app-related barriers, the system improves accessibility and increases the likelihood of user engagement and task completion.

As illustrated in FIG. 3B, a user initiates a message 342 via SMS stating, “I need to verify my income”. This message 342 is received by the system and parsed by the NLP and intent engine 142, which classifies the intent as a request to upload income verification documentation. In response, the assistant replies with a prompt 346 such as, “Would you like to upload a recent pay stub or link your payroll provider?” If the user responds with “upload” (348), the secure link generator 146 creates a secure, time-limited hyperlink 352 delivered via SMS. When the user taps the link, a browser-based chat session opens within the web-based chat interface 318, as illustrated in FIG. 3C. Within this interface, the user is presented with a contextual prompt 362 instructing, “Please upload your most recent pay stub,” and an embedded document upload widget 366 that accepts file input. Upon successful upload, the assistant may confirm receipt and request additional supporting documentation if needed (e.g., a W-2 or offer letter).

The uploaded document is stored in the user's session folder 324, where it is tagged with relevant metadata such as document type, upload timestamp, and source channel. These tags enable downstream processing for underwriting, validation, or audit purposes and remain accessible throughout the session via the session manager 148 and data store 108.

In some embodiments, the SMS conversation thread rendered in the native messaging application 316 preserves a partial mirror of the web chat interaction. Sensitive data fields are masked using the data masking and redaction module 150, ensuring that no protected content is exposed over SMS. The user may later reopen the native messaging app and resume interaction by replying with a follow-up message.

For example, a user may initiate a chat via SMS, clicks the secure link, and begins providing details for a loan application. Midway through, they close the browser. Three days later, the user sends another SMS to the same number, writing ‘Can I continue where I left off?’ The session manager 148 illustrated in FIG. 1B, recognizes the mobile number and checks for active sessions within the defined retention window. A new secure link is generated and sent. When activated, the user is returned to the prior state, including filled-in data fields, document uploads, chat history, and assistant memory. This frictionless resume experience increases conversion rates and reduces abandonment.

In some embodiments, the conversational assistant (AA), may be configured to handle the initial interaction. If the system detects ambiguity, frustration, or task complexity, it may escalate to a human assistant (HA), e.g., “Vishant.” The conversation transitions into a collaborative context where both AA and HA contribute. In some embodiments, the HA may edit or override assistant responses—replacing text or inserting corrections while preserving audit traces. This interaction is managed through the HA integration module 236 illustrated in FIG. 2 and monitored via the audit logging module 152 illustrated in FIG. 1B.

In some embodiments, the AA may determine that a specialized HA is required based on user intent or conversation history. For example, if a user shifts from application questions to interest rate inquiries, the system may escalate to a licensed loan originator. The assistant uses historical engagement data (e.g., from historical interaction data store 251), user sentiment analysis, and conversation topic modeling to select the most appropriate HA. Escalation decisions may also incorporate satisfaction indicators tracked in the satisfaction index modeling store 253, enabling context-aware HA selection based on both user behavior and prior resolution effectiveness.

If the escalation is not triggered automatically by the AA, but instead occurs via manual HA intervention, the system captures and logs the transition event. These events are used as training data for future routing and handoff optimization, further improving assistant intelligence and escalation accuracy over time.

In some embodiments, the system 100 may control message collision between the AA and HA to prevent user confusion. If the AA sends a clarification but the HA intervenes shortly afterward, the assistant's message may be struck through or marked as superseded. The HA may edit or revise prior AI responses in-line. This interaction model 236 ensures that the user always sees a coherent message stream while preserving transparency around system-versus-human responses.

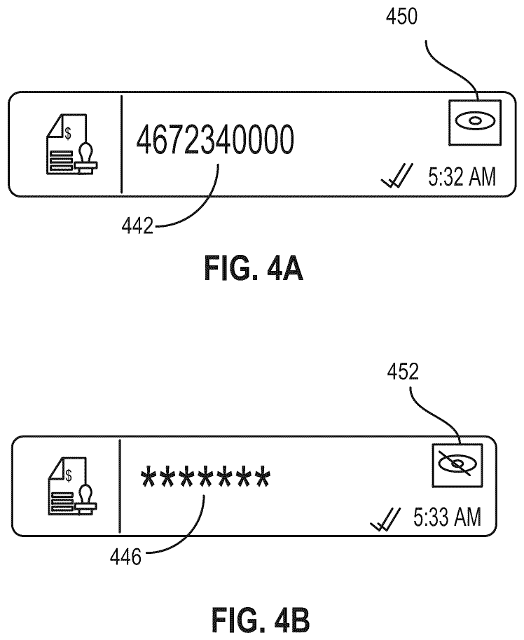

In some embodiments, the user may be prompted to provide personal identifiable information (PII) or other confidential data such as phone numbers, addresses, income figures, Social Security numbers, or financial account details through the web-based chat interface. To reduce risk of exposure, the system 100 enables a data masking feature that allows sensitive information to be obscured after entry. As illustrated in FIG. 4A, a masking toggle 450—represented by an “eye” icon—is displayed adjacent to input fields within the web chat UI 128. When the user clicks this icon, the system masks the corresponding content (e.g., account number 442) and updates the message display.

The masked message (e.g., 446 in FIG. 4B) replaces the original sensitive data with symbolic characters such as asterisks. The eye icon 450 is replaced with a visually distinct “masked” version 452 (e.g., an eye with a strikethrough), indicating that the field is hidden. This masking is applied both in the web interface and in any mirrored version of the message sent back to the SMS channel, using logic executed by the data masking and redaction module 150 illustrated in FIG. 1B.

In some embodiments, the system uses machine learning models trained to detect PII and confidential content based on input structure, entity recognition, and historical masking behavior. If sensitive content is detected, the system may proactively mask it-even if the user has not manually triggered the icon. The user may override this decision by revealing or re-masking the data. Over time, user interactions with this feature improve the accuracy of automated masking, as the model is updated based on accepted overrides and usage feedback.

Additionally, users may explicitly indicate that specific information is confidential through their input. For example, the user may enter: “Here is my confidential mailing address: 12339 185th Street, Cerritos, California 90703.” The inclusion of the term “confidential” triggers masking of the associated address. Similarly, a user may provide a data point first, then follow up with a clarification such as, “BTW, keep that confidential,” to retroactively mark a previous message for masking.

In embodiments involving joint applications, one user may initiate the interaction and provide a co-borrower's contact details. The system captures the primary user's inputs and masks any sensitive data mirrored to the SMS thread. A separate session is created for the co-borrower using a tokenized invitation link. The system ensures both users' data remain associated with a shared application folder, while preserving session-specific views and permissions. Session threading and audit logs maintain full traceability of who submitted what and when.

In some embodiments, the system 100 may be built to handle edge cases that may arise from real-world use, including malformed messages, expired tokens, device mismatches, and conflicting user sessions. For example, when an incoming SMS cannot be parsed due to gibberish, missing punctuation, or unknown format, the NLP engine 142 assigns a ‘low confidence’ score to the message. The assistant responds with a gentle clarifying message and may log the case for review if repeated unparseable inputs are received from the same number. If a user clicks an expired secure link or reuses a token, the system displays a custom error page and offers to resend a fresh link. Session continuity is preserved where possible, based on phone number, timestamp, or message history.

If a token is activated from a device that differs from the original session device (as determined via headers or IP metadata), the system may request an additional verification step before restoring access. This includes sending a confirmation SMS or requiring reauthentication.

In the case of concurrent sessions from multiple devices or users (e.g., co-borrower and primary), the session manager 148 isolates each session using a thread identifier. Updates made in one session are reflected only after confirmation, and masking rules apply per session view.

In some embodiments, the system 100 includes proactive engagement logic that detects stalled workflows and re-engages the user after a period of inactivity. This feature improves completion rates by prompting users to resume their session at the optimal moment based on behavioral patterns. The system 100 monitors user behavior, such as form abandonment, idle periods in chat, or incomplete sections. Based on predefined thresholds (e.g., no interaction for 24 hours), the session manager 148 triggers the generation of a personalized follow-up message. This may include a brief status update or a context-specific nudge like, ‘You're almost done with your application. Tap here to finish.’ For example, these nudges may be transmitted via SMS, email, or push notification depending on the user's prior consent and device capabilities. The system 100 selects the communication channel with the highest likelihood of engagement. If the user clicks the link in a follow-up SMS, they are returned to their previously paused state, preserving inputs and assistant memory.

In some embodiments, the AI assistant (AA) may also provide brief summaries of what's left to complete. For example, ‘You've completed your contact info and income verification. Just one more document to go!’ This provides positive reinforcement while clarifying next steps. In yet other embodiments, the system 100 integrates calendar-aware nudging. If a user interacts with the assistant during weekday work hours but drops off in the evening, the follow-up may be delayed until the next business morning. The AI assistant's response windows can be tuned per user preference, engagement profile, and/or using such similar mechanism.

In some embodiments, the system 100 may include pre-configured workflow templates designed to assist users in completing common tasks more efficiently. For example, these templates are triggered by intent signals within user messages and map to predefined sequences of questions, document requests, and form interactions. Templates may be stored in a modular, reusable format, allowing the assistant to adapt content to different verticals (e.g., mortgage, healthcare, government).

When a user sends a message like ‘I moved recently,’ the NLP engine 142 matches the input to the ‘address update’ template. The system 100 then initiates a micro-conversation that gathers the new address, prompts for a document (e.g., utility bill), and offers to update related records across all linked sessions or applications.

If a user indicates they need to upload a W-2 form, the assistant activates a secure file upload path, confirms document type, and triggers OCR validation or data extraction. The assistant also provides contextual tips to reduce user error, such as reminders about file format and ensuring the form year matches the current tax cycle.

If a user says, ‘I changed banks,’ the system responds with the re-authentication template, prompting them to reconnect their payroll or financial accounts using secure API integrations or by uploading a recent statement. In other embodiments, the workflow may include automatic disassociation of outdated accounts and notifies the user once the update is complete.

In some embodiments, the system 100 architecture may be designed to support multi-tenant deployments, enabling multiple organizations to use the platform concurrently with isolated datasets, custom workflows, and branded interfaces. A tenant refers to an individual client organization or enterprise (e.g., a mortgage lender, bank, healthcare provider, or insurance firm) that uses a logically isolated instance of the platform—including its users, data, workflows, and branding—within a shared technical infrastructure. Each tenant may have its own configuration profile that includes authentication logic, branding assets, workflow templates, and notification preferences. Tenants are assigned unique keys used to namespace all interactions. For example, user session data, masked content, uploaded documents, and assistant memory are partitioned under the tenant ID. This isolation allows mortgage lenders, healthcare providers, or financial institutions to operate independently while using a shared platform backbone.

In some embodiments, the system 100 may support tenant-specific configuration of prompt tone, masking rules, AI fallback behavior, and secure link formatting. Multi-tenant deployment also enables usage analytics, access controls, and escalation logic to be tailored per client.

In some embodiments, the system may include a robust compliance and audit framework to ensure accountability, traceability, and regulatory compatibility. For example, all user interactions, assistant prompts, session transitions, and masking events are recorded in a secure, structured audit log. These logs can be used to verify compliance with industry regulations such as GLBA, HIPAA, or GDPR, depending on deployment context. Each log entry may be time-stamped and associated with the following metadata fields: session ID, tenant ID (for multi-tenant configurations), user phone number (hashed), Interaction type (inbound SMS, mirrored response, prompt, upload, etc.), NLP intent classification and confidence score, action taken (e.g., generated secure link, masked PII, resumed session), associated document IDs or input fields, AI fallback trigger (if used), human assistant handoff (if applicable), audit trace ID for cross-system integration, and/or other such similar metadata fields.

In some embodiments, audit logs may be stored in an encrypted log store and may be exported in formats including JSON, XML, or CSV for compliance review. Administrators may query audit logs based on session duration, masking frequency, abandoned sessions, or prompt effectiveness. Logs may also be streamed in real time to SIEM platforms or compliance dashboards. The audit infrastructure may be designed to support retrospective investigation as well as proactive policy enforcement. For example, if a tenant configures masking thresholds for certain keywords or number patterns (e.g., SSN, routing numbers), the audit engine can flag violations, notify compliance officers, and adjust assistant behavior automatically.

In some embodiments, the system 100 may be engineered to support high volumes of concurrent SMS interactions and mirrored chat sessions without degradation in performance. To achieve scalable responsiveness, it incorporates distributed load balancing, message queueing, rate limiting, and asynchronous processing across all modules.

For example, incoming SMS messages may be queued and processed via a parallel message broker architecture, ensuring fault tolerance and retry logic. The NLP engine 142 may operate in a containerized, stateless mode with memory cache to enable rapid boot-up and scale-out under load. Cached session fragments reduce latency when restoring in-progress workflows.

To prevent abuse, the SMS Gateway and Secure Link Generator enforce rate limits per user, per IP, and per tenant. Limits may include a maximum number of messages per minute, secure links per hour, or session resumes per day. Rate-limiting responses are logged and may trigger alerting mechanisms if exceeded repeatedly.

Behavioral patterns indicating automated bots, spam inputs, or credential stuffing are flagged by an anomaly detection module, which can throttle or temporarily block interaction pending verification. Token generation for secure links includes safeguards against enumeration attacks and replay scenarios.

In some embodiments, each assistant instance may be lifecycle-aware. For example, when a session is initiated, the assistant enters an ‘active’ state. After a period of inactivity, such as 15 minutes without input, the instance transitions to an ‘idle’ state, preserving context but pausing resource-intensive processes. Upon re-engagement, it returns to active, resuming prior memory without delay.

In some embodiments, inactive assistant sessions may be garbage-collected after a tenant-defined expiration window (e.g., 72 hours). All state data is written to persistent stores, allowing for cold start context reconstruction if needed. This approach enables performance scaling while optimizing memory and compute consumption per active session.

In some embodiments, multi-tenant deployments may support individual assistant profiles, each with its own lifecycle strategy. For example, a banking tenant may maintain longer assistant memory retention than a promotional campaign or government intake form. This granularity ensures contextual optimization per use case.

In some embodiments, the system may support intelligent ingestion of user-uploaded documents, such as pay stubs, W-2s, utility bills, bank statements, or identification forms. Once uploaded through the secure web interface, documents are routed to a processing pipeline that performs type classification, metadata extraction, and optional OCR parsing.

In some embodiments, the classification model may be trained to detect document type based on structural elements (e.g., headers, logos, form fields), text density, and embedded metadata. Upon classification, the assistant dynamically adjusts the workflow. For example, if the uploaded file is identified as a bank statement, the assistant may prompt the user to confirm account ownership or link it to a financial verification process.

In some embodiments, the system may use an OCR engine to extract machine-readable text from scanned or photographed documents. Extracted data may be passed through a field validator, which compares values to session context (e.g., does the name on the document match the session identity?) or checks expected ranges (e.g., income, dates, ZIP codes). OCR confidence scores may be used to guide assistant behavior. If a critical value is missing or confidence is low, the assistant may ask the user to re-upload or enter the value manually. All extracted values are stored in the structured user data store and linked to the original document ID for traceability.

Uploaded documents are automatically tagged with metadata fields, including, upload timestamp, uploader ID, document type, linked session ID, form field references, and masking status. These tags allow the system to index documents within user folders, enable breadcrumb navigation, and support filtering for downstream review or automated routing.

In some embodiments, the system 100 may also suggest document associations based on NLP cues from the conversation (e.g., ‘here's my ID’→auto-tagged as government-issued photo ID). All associations are logged in the audit system and can be overridden by the user or compliance staff if incorrect.

In some embodiments, the system may include a chat mirroring engine configured to selectively transmit assistant-generated responses or user-submitted messages from the secure web-based chat interface back to the SMS channel. The goal of this module is to preserve the conversational flow across platforms while ensuring that no sensitive information is exposed through SMS. In some embodiments, the chat mirroring engine may evaluate each outgoing message according to the following criteria: determine whether the message originated from the assistant or the user; check the content of the message against masking policies using regular expressions and/or trained classifiers; evaluate message type—e.g., status confirmation, prompt, document reminder—and whether it is safe to reflect in SMS; apply masking logic if needed (sensitive portions are obfuscated using placeholders (e.g., **-6789) before being mirrored); and transmit the masked message via the SMS Gateway and record both masked/unmasked versions in the audit log. Messages deemed too sensitive or ambiguous are withheld from SMS and instead retained in the secure web chat. This approach balances user awareness, continuity, and privacy compliance.

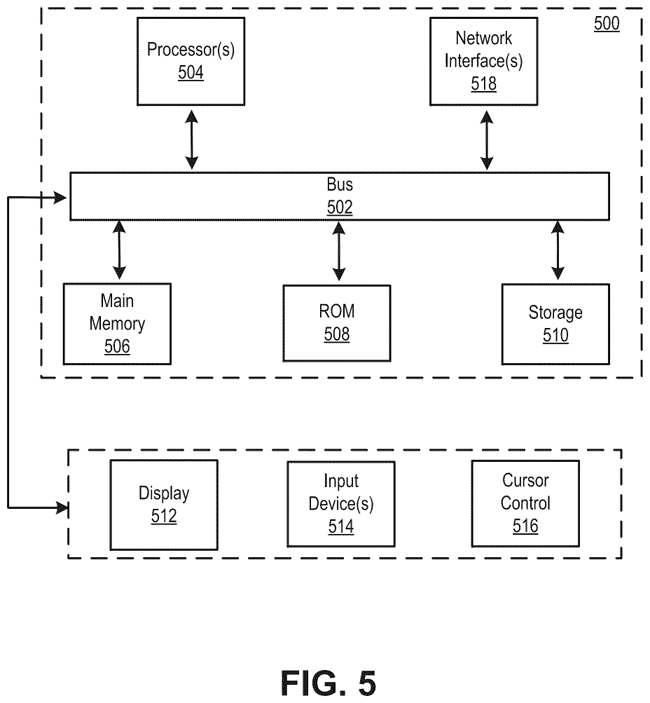

In some embodiments, the system 100 may support SMS-based session resumption, allowing users to re-enter an active or previously paused session by sending a follow-up SMS. When an inbound SMS is received from a known user number, the session manager 148 initiates a lookup of recent session history. In some embodiments, session retrieval may be based on phone number match, message context, and recency window (e.g., sessions within the last 72 hours). The system may be configured to first parse the incoming SMS for intent (e.g., ‘Can I continue?’, ‘Resume application’). Then, if a valid session is found, generate a new secure link tied to the stored session context. Next, send the link via SMS, along with a short status update (e.g., ‘You're halfway through your form. Tap to resume.’). Next, upon link activation, the system 100 may be configured to reload the assistant state, form progress, and document metadata from the session store. Finally, the system may be configured to log the re-engagement event with timestamps, user identifiers, and continuity status. This passive re-engagement model supports frictionless user interaction without requiring manual re-entry of data or log-in credentials.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 5. Various embodiments are described in terms of this example computing module 500. After reading this description, it will become apparent to a person skilled in the relevant art how to implement the technology using other logical circuits or architectures.

FIG. 5 illustrates an example computing module 500, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the application using other computing modules or architectures.

Referring now to FIG. 5, computing module 500 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally. The bus 502 may also be connected to other components such as a display 512, input devices 55, or cursor control 516 to help facilitate interaction and communications between the processor and/or other components of the computing module 500.

Computing module 500 might also include one or more memory modules, simply referred to herein as main memory 506. For example, preferably random-access memory (RAM) or other dynamic memory might be used for storing information and instructions to be executed by processor 504. Main memory 506 might also be used for storing temporary variables or other intermediate information during execution of instructions to be executed by processor 504. Computing module 500 might likewise include a read only memory (“ROM”) 508 or other static storage device 510 coupled to bus 502 for storing static information and instructions for processor 504.

Computing module 500 might also include one or more various forms of information storage devices 510, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 510 might include other similar instrumentalities for allowing computer programs or other instructions or data to be loaded into computing module 500. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 500.

Computing module 500 might also include a communications interface or network interface(s) 518. Communications or network interface(s) interface 518 might be used to allow software and data to be transferred between computing module 500 and external devices. Examples of communications interface or network interface(s) 518 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 518 might typically be carried on signals, which can be electronic, electromagnetic (which includes optical) or other signals capable of being exchanged by a given communications interface. These signals might be provided to communications interface 518 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 506, ROM 508, and storage unit interface 510. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method maintaining a secure mirrored interaction between SMS and a web-based chat interface, the method comprising:
initiating a chat session between a user and a conversational interface via a secure web link delivered through SMS;
mirroring conversation updates from the web-based interface to the user via SMS;
detecting sensitive data in mirrored content based on natural language processing and redaction rules;
masking sensitive content in outbound SMS messages by applying obfuscation or placeholder tokens;
persisting chat history and structured data in a session store linked to the user; and
resuming the chat session via SMS upon receiving a follow-up message, restoring prior context and chat history.

2. The method of claim 1, wherein sensitive data includes at least one of Social Security numbers, banking information, or residential addresses.

3. The method of claim 1, wherein the system uses a trained model to distinguish contextually sensitive vs. reusable data.

4. The method of claim 1, wherein resumption of the session includes restoration of prior form state and uploaded documents.

5. The method of claim 1, further comprising logging all masking actions in an audit log.

6. The method of claim 1, wherein the user is notified via SMS that a redacted version of the original message has been delivered.

7. The method of claim 1, wherein mirrored updates are sent only when sensitive data is successfully redacted.

8. The method of claim 1, wherein the session is stored in encrypted form with device-independent access tokens.

9. The method of claim 1, wherein the mirrored chat includes icon indicators showing which fields were masked.

10. The method of claim 1, wherein the session recovery is initiated based on message content pattern matching or recognition of a known keyword.

11. A computer-implemented system for mirrored SMS interaction and secure data redaction, the system comprising:
a web-based chat interface configured to collect user inputs and drive a structured conversation;
an SMS mirroring engine configured to transmit chat updates via SMS in real time;
a masking module configured to detect and redact sensitive data before delivery to the SMS channel;
a session persistence module configured to store and retrieve chat history, structured form data, and masking actions;
a session recovery engine configured to match inbound SMS messages to prior sessions and rehydrate chat context;
and a logging module configured to track redaction events, session states, and data recovery outcomes.

12. The system of claim 11, wherein the masking module uses context-aware regular expressions and a trained classifier.

13. The system of claim 11, wherein the session recovery engine associates new SMS messages with sessions using mobile number, timestamp, and keyword matching.

14. The system of claim 11, wherein the session persistence module is implemented with a secure key-value store.

15. The system of claim 11, wherein the SMS mirroring engine applies rate-limiting to avoid SMS overuse.

16. The system of claim 11, wherein the chat interface highlights fields that are mirrored vs. fields withheld for privacy.

17. The system of claim 11, further comprising a real-time alert engine to notify the user when masking occurs.

18. The system of claim 11, wherein the logging module supports export in compliance with financial recordkeeping standards.

19. The system of claim 11, wherein the session persistence module includes folder mapping and document metadata.

20. The system of claim 11, wherein mirrored messages are visually annotated to indicate their security classification.
